(19) United States
(12) Patent Application Publication
(10) Pub. No.: US 2026/0322280 A1
(43) Pub. Date: Oct. 15, 2026

(54) POWER SUPPLY CONTROL DEVICE AND SWITCHING POWER SUPPLY DEVICE

(71) Applicant: ROHM CO., LTD., Kyoto (JP)

(72) Inventor: Isao TAKOBE, Kyoto (JP)

(21) Appl. No.: 19/642,184

(22) Filed: Apr. 8, 2026

(30) Foreign Application Priority Data
Apr. 14, 2025 (JP) 2025-066427

(51) Int. Cl. H02M 3/335; H02M 1/088; H02M 3/00

(52) U.S. Cl. CPC H02M 3/33571; H02M 1/088; H02M 3/01

(57) ABSTRACT

A power supply control device drives and controls an LLC resonant converter. The power supply control device includes a control circuit that performs at least one of: first control in which when a first switch element is in an on state, if it is detected that a current flows from a resonant capacitor toward a primary winding based on a voltage output from a high-pass filter configured to receive a current sense signal corresponding to a current flowing through the primary winding or a sign thereof is detected, the first switch element is turned off; and second control in which when a second switch element is in an on state, if it is detected that a current flows from the primary winding toward the resonant capacitor based on the voltage output from the high-pass filter or a sign thereof is detected, the second switch element is turned off.

### CROSS-REFERENCE TO RELATED APPLICATIONS

This nonprovisional application claims priority under 35 U.S.C. § 119(a) on Patent Application No. 2025-066427 filed in Japan on Apr. 14, 2025, the entire contents of which are hereby incorporated by reference.

### BACKGROUND OF THE INVENTION

### 1. Technical Field

The present disclosure relates to power supply control devices and switching power supply devices.

### 2. Description of Related Art

The applicant of the present application has previously proposed a large number of new technologies related to LLC resonant DC/DC converters (hereinafter also referred to as LLC resonant converters) (see, for example, Japanese Unexamined Patent Application No. 2020-78152).

### BRIEF DESCRIPTION OF THE DRAWINGS

FIG. 1 is a diagram showing the configuration of a switching power supply device according to an embodiment of the present disclosure;

FIG. 2 is an external perspective view of a semiconductor device;

FIG. 3 is a diagram for illustrating the operation of the switching power supply device in a first mode;

FIG. 4 is a diagram for illustrating the operation of the switching power supply device in a second mode;

FIG. 5 is a diagram for illustrating the operation of the switching power supply device in a third mode;

FIG. 6 is a diagram for illustrating the operation of the switching power supply device in a fourth mode;

FIG. 7 is a diagram for illustrating the operation of the switching power supply device in a fifth mode;

FIG. 8 is a diagram for illustrating the operation of the switching power supply device in a sixth mode;

FIG. 9 is a diagram for illustrating the operation of the switching power supply device in a seventh mode;

FIG. 10 is a diagram for illustrating the operation of the switching power supply device in an eighth mode;

FIG. 11 is a diagram for illustrating the operation of the switching power supply device in a ninth mode;

FIG. 12 is a diagram for illustrating the operation of the switching power supply device in a tenth mode;

FIG. 13 is a diagram showing operation waveforms of the switching power supply device;

FIG. 14 is a diagram showing an example of the configuration of a determination circuit;

FIG. 15 is a diagram showing a variation of the switching power supply device according to the embodiment of the present disclosure;

FIG. 16 is a diagram showing another variation of the switching power supply device according to the embodiment of the present disclosure; and

FIG. 17 is a diagram showing yet another variation of the switching power supply device according to the embodiment of the present disclosure.

### DETAILED DESCRIPTION

### <Configuration of Switching Power Supply Device>

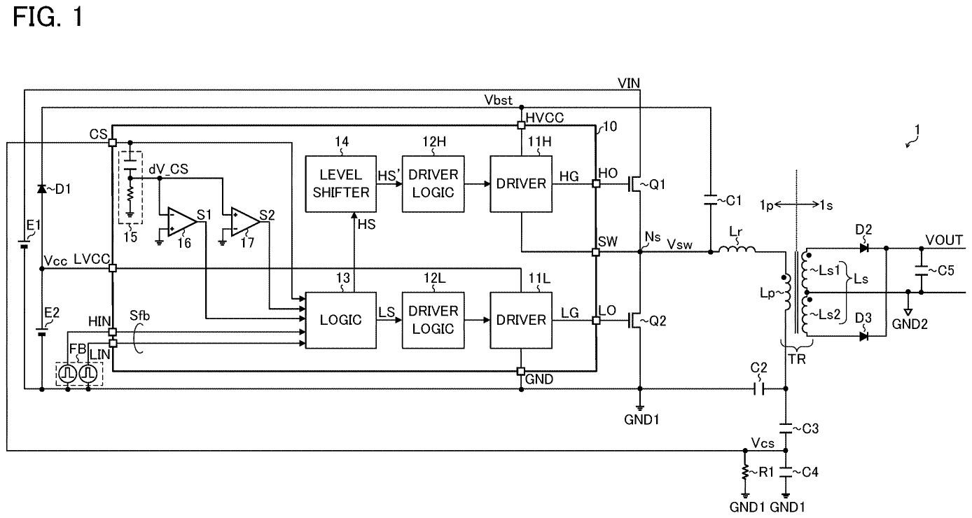

FIG. 1 is a diagram showing the configuration of a switching power supply device according to an embodiment of the present disclosure. The switching power supply device 1 includes an LLC resonant isolated DC/DC converter which generates a desired direct-current output voltage VOUT from a direct-current input voltage VIN while electrically isolating an area between a primary circuit system 1p (GND1 system) and a secondary circuit system 1s (GND2 system).

The switching power supply device 1 includes voltage sources E1 and E2, a semiconductor device 10, an output feedback circuit FB and various discrete components (an upper switch element Q1, a lower switch element Q2, a transformer TR, capacitors C1 to C5, diodes D1 to D3 and an inductor Lr). Although in FIG. 1, the upper switch element Q1 and the lower switch element Q2 are N-channel switch elements, they may be switch elements other than N-channel switch elements.

When an alternating-current input voltage is input to the switching power supply device 1, a preceding stage circuit (such as a diode bridge or a power factor correction circuit) which rectifies and smoothes the alternating-current input voltage to generate the direct-current input voltage VIN is preferably provided instead of the voltage source E1.

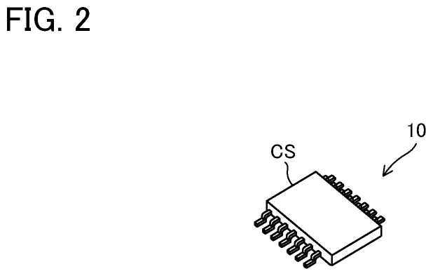

The semiconductor device 10 is a main controller (so-called power supply control device) of the switching power supply device 1. The semiconductor device 10 includes, as means for establishing electrical connection to the outside of the device, a plurality of external terminals (an HVCC pin, an HO pin, an SW pin, an LO pin, a GND pin, an LIN pin, an HIN pin, an LVCC pin and a CS pin). FIG. 2 is an external perspective view of the semiconductor device 10. The semiconductor device 10 is an electronic component including a semiconductor chip which includes a semiconductor integrated circuit formed on a semiconductor substrate, a housing CS (package) which contains the semiconductor chip and a plurality of external terminals which are exposed to the outside of the semiconductor device 10 from the housing CS. The semiconductor chip is sealed in the housing CS made of resin to form the semiconductor device 10. The number of external terminals of the semiconductor device 10 and the type of housing CS of the semiconductor device 10 shown in FIG. 2 are merely examples, and can be designed arbitrarily. The HVCC pin, the HO pin, the SW pin, the LO pin, the GND pin, the LIN pin, the HIN pin, the LVCC pin and the CS pin are parts of the plurality of external terminals provided in the semiconductor device 10. External terminals other than those described above can be provided in the semiconductor device 10.

The transformer TR includes: a primary winding Lp which is provided in the primary circuit system 1p; and a secondary winding Ls which is provided in the secondary circuit system 1s and is magnetically coupled to the primary winding Lp.

The first end (in FIG. 1, the winding start end) of the primary winding Lp is connected to the first end of the inductor Lr. The second end of the inductor Lr is connected to a connection node Ns between the source of the upper switch element Q1 and the drain of the lower switch element Q2. The second end of the inductor Lr is also connected to the SW pin of the semiconductor device 10. The second end (in FIG. 1, the winding stop end) of the primary winding Lp is connected to the first end of the capacitor C2 and the first end of the capacitor C3. The second end of the capacitor C2 is connected to the source of the lower switch element Q2, the GND pin of the semiconductor device 10 and the ground end (=the application end of a ground voltage GND1) of the primary circuit system 1p. The second end of the capacitor C3 is connected to the first end of the capacitor C4, the first end of a resistor R1 and the CS pin of the semiconductor device 10. The second end of the capacitor C4 and the second end of the resistor R1 are connected to the ground end of the primary circuit system 1p. The capacitors C3 and C4 capacitively divide a voltage generated at a connection node between the primary winding Lp and the capacitor C2 to generate a voltage Vcs. The voltage Ves is a signal (current sense signal) which includes information of a current flowing through the primary winding Lp. By the resistor R1 in which the second end is connected to the ground end (0 [V]) of the primary circuit system 1p, the voltage Vcs serves as the signal which swings positively and negatively.

The transformer TR may be a leakage transformer or a resonant transformer. In other words, the inductor Lr may be the leakage inductance of the transformer TR.

The first end (for example, the winding start end) of a secondary winding Ls1 is connected to the anode of the diode D2. The first end (for example, the winding stop end) of a secondary winding Ls2 is connected to the anode of the diode D3. The cathodes of the diodes D2 and D3 and the first end of the capacitor C5 are connected to the application end of the direct-current output voltage VOUT. The second end (for example, the winding stop end) of the secondary winding Ls1, the second end (for example, the winding start end) of the secondary winding Ls2 and the second end of the capacitor C5 are connected to the ground end (=the application end of a ground voltage GND2) of the secondary circuit system 1s. The secondary windings Ls1 and Ls2 can be understood as a single secondary winding Ls which has a center tap.

The transformer TR, the inductor Lr, the diode D2, the diode D3, the capacitor C2, the capacitor C5, the upper switch element Q1 and the lower switch element Q2 connected as described above form an LLC resonant switching output stage which generates the desired direct-current output voltage VOUT from the direct-current input voltage VIN. In particular, the diodes D2 and D3 and the capacitor C5 function as a rectifying and smoothing circuit which rectifies and smoothes an induced voltage generated in the secondary winding Ls to generate the direct-current output voltage VOUT.

The positive end of the voltage source E1 (=the application end of the direct-current input voltage VIN) is connected to the drain of the upper switch element Q1. The positive end of the voltage source E2 (=the application end of a power supply voltage Vcc) and the anode of the diode D1 are connected to the LVCC pin of the semiconductor device 10. The negative ends of the voltage sources E1 and E2 are connected to the GND pin of the semiconductor device 10 (=the application end of the ground voltage GND1). The cathode of the diode D1 and the first end of the capacitor C1 are connected to the HVCC pin of the semiconductor device 10 (=the application end of a step-up voltage Vbst). The second end of the capacitor C1 is connected to the connection node Ns.

The diode D1 and the capacitor C1 connected as described above function as a bootstrap circuit for generating the step-up voltage Vbst which is constantly higher than a switch voltage Vsw applied to the connection node Ns by a voltage VC across the capacitor C1 (≈Vcc−Vf where Vf is the forward drop voltage of the diode D1). Specifically, when Vsw≈0 V (GND1), Vbst≈VC whereas when Vsw≈VIN, Vbst≈VIN+VC.

The output feedback circuit FB generates a feedback signal Sfb corresponding to the direct-current output voltage VOUT, and outputs the feedback signal Sfb to the HIN pin and the LIN pin of the semiconductor device 10. The configuration of the output feedback circuit FB is not limited. For example, the output feedback circuit FB generally has a configuration using a shunt regulator and a photocoupler, a configuration using an auxiliary winding of the transformer TR or the like.

The gate of the upper switch element Q1 is connected to the HO pin of the semiconductor device 10 (=the application end of an upper gate signal HG). When the upper gate signal HG is high (≈Vbst), the upper switch element Q1 is in an on state whereas when the upper gate signal HG is low (≈Vsw), the upper switch element Q1 is in an off state.

The gate of the lower switch element Q2 is connected to the LO pin of the semiconductor device 10 (=the application end of a lower gate signal LG). When the lower gate signal LG is high (≈Vcc), the lower switch element Q2 is in an on state whereas when the lower gate signal LG is low (≈GND1), the lower switch element Q2 is in an off state.

The upper switch element Q1 and the lower switch element Q2 may be, for example, Si devices or GaN devices. The GaN device may be a combination of a GaN-HEMT [high electron mobility transistor] and a MOSFET [metal oxide semiconductor field effect transistor]. The term “MOSFET” in the present specification means a field effect transistor in which a gate structure is formed with at least three layers of a “layer made of a conductor or a semiconductor such as polysilicon having a low resistance value”, an “insulating layer” and a “P-type, N-type or intrinsic semiconductor layer”. In other words, the gate structure of the MOSFET is not limited to a three-layer structure of metal, oxide and semiconductor.

Although in FIG. 1, the upper switch element Q1 and the lower switch element Q2 are externally connected to the semiconductor device 10 as discrete elements, they may be incorporated in the semiconductor device 10 as integrated elements.

### <Configuration of Semiconductor Device>

The semiconductor device 10 includes an upper driver 11H, a lower driver 11L, an upper drive logic 12H, a lower drive logic 12L, a logic 13, a level shifter 14, a high-pass filter 15 and comparators 16 and 17.

The upper driver 11H generates the upper gate signal HG. The upper driver 11H are connected to the HVCC pin, the SW pin and the HO pin.

The lower driver 11L generates the lower gate signal LG. The lower driver 11L is connected to the LVCC pin, the GND pin and the LO pin.

The upper drive logic 12H drives and controls the upper driver 11H according to a level-shifted upper control signal HS′. For example, when the level-shifted upper control signal HS' is high, the upper drive logic 12H drives and controls the upper driver 11H such that the upper gate signal HG is high. On the other hand, when the level-shifted upper control signal HS' is low, the upper drive logic 12H drives and controls the upper driver 11H such that the upper gate signal HG is low.

The lower drive logic 12L drives and controls the lower driver 11L according to a lower control signal LS. For example, when the lower control signal LS is high, the lower drive logic 12L drives and controls the lower driver 11L such that the lower gate signal LG is high. On the other hand, when the lower control signal LS is low, the lower drive logic 12L drives and controls the lower driver 11L such that the lower gate signal LG is low.

The logic 13 generates an upper control signal HS and the lower control signal LS so as to complementarily control the turning on and off of the upper switch element Q1 and the lower switch element Q2 according to the feedback signal Sfb input to the HIN pin and the LIN pin.

The term “complementary” in the present specification can be broadly interpreted to include not only a case where the on/off states of the upper switch element Q1 and the lower switch element Q2 are completely reversed but also a case where a delay is provided to the on/off transition timing of the upper switch element Q1 and the lower switch element Q2 (a case where a so-called simultaneous off period (dead time) is provided).

For the output feedback control performed by the logic 13, an existing known technique (such as a voltage mode control method, a current mode control method or a hysteresis control method) can be applied. When the current mode control method is applied, the logic 13 generates the upper control signal HS and the lower control signal LS according to the feedback signal Sfb input to the HIN pin and the LIN pin and the voltage Vcs input to the CS pin.

The level shifter 14 shifts the signal level of the upper control signal HS to generate the level-shifted upper control signal HS′.

The high-pass filter 15 includes a capacitor and a resistor, receives the voltage Vcs input to the CS pin, converts the voltage Ves into a voltage dV_CS and supplies the voltage dV_CS to the inverting input terminal of the comparator 16 and the non-inverting input terminal of the comparator 17. The ground voltage GND1 is applied to the non-inverting input terminal of the comparator 16 and the inverting input terminal of the comparator 17. A comparison result signal S1 output from the comparator 16 and a comparison result signal S2 output from the comparator 17 are supplied to the logic 13. The logic 13 uses the comparison result signals S1 and S2 to perform countermeasures against resonance deviation which will be described later.

### <Basic Operation of Switching Power Supply Device>

The switching power supply device 10 controls the direct-current output voltage VOUT using a frequency modulation method which changes the switching frequencies fsw of the upper switch element Q1 and the lower switch element Q2. The switching power supply device 10 has a resonant frequency fsr represented by the following equation (1) and a resonant frequency fpr represented by the following equation (2). Lr in the following equations (1) and (2) is the inductance of the inductor Lr, Cr in the following equations (1) and (2) is the capacitance of the capacitor C2 and Lm in the following equation (2) is the inductance of the primary winding Lp.

$$\begin{matrix}fsr = \frac{1}{2 π \sqrt{L r C r}} & ( 1 ) \\ fpr = \frac{1}{2 π \sqrt{( L r + L m ) C r}} & ( 2 )\end{matrix}$$

When the switching frequency fsw is set higher than the resonant frequency fpr and lower than the resonant frequency fsr, and a gain (=VOUT/VIN) in the switching power supply device 10 is greater than 1, the switching power supply device 10 repeats the operation of the first to tenth modes below.

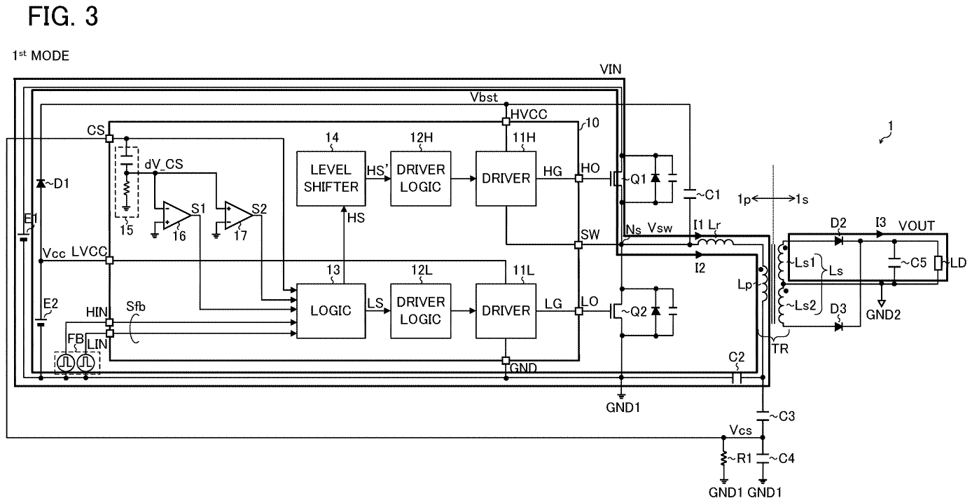

In the first mode, the upper switch element Q1 is in an on state, and the lower switch element Q2 is in an off state. As shown in FIG. 3, in the primary circuit system 1p, a load current I1 and an excitation current I2 flow, and in the secondary circuit system 1s, a load current I3 flows via the diode D2. The load current I3 is a sinusoidal current caused by resonance between the inductor Lr and the capacitor C2. When the load current I3 becomes 0 [A], the operation of the switching power supply device 10 transitions from the first mode to the second mode.

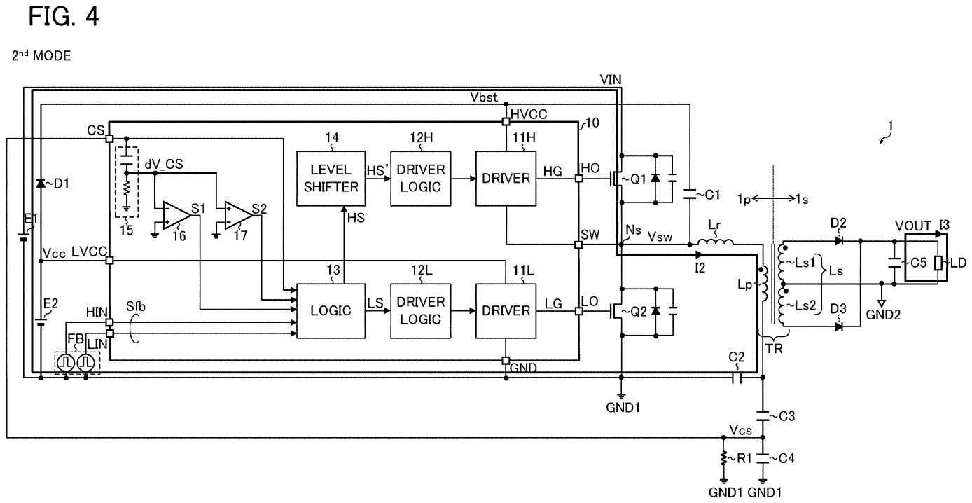

In the second mode, as in the first mode, the upper switch element Q1 is in an on state, and the lower switch element Q2 is in an off state. As shown in FIG. 4, in the primary circuit system 1p, the load current I1 is 0 [A] but the excitation current I2 continues to flow, and in the secondary circuit system Is, the load current I3 flows from the capacitor C5 to a load LD. The capacitor C2 is charged by the excitation current I2. As the period of the second mode, that is, the charging period of the capacitor C2 is longer, the charge amount of the capacitor C2 is increased, and thus the direct-current output voltage VOUT is increased.

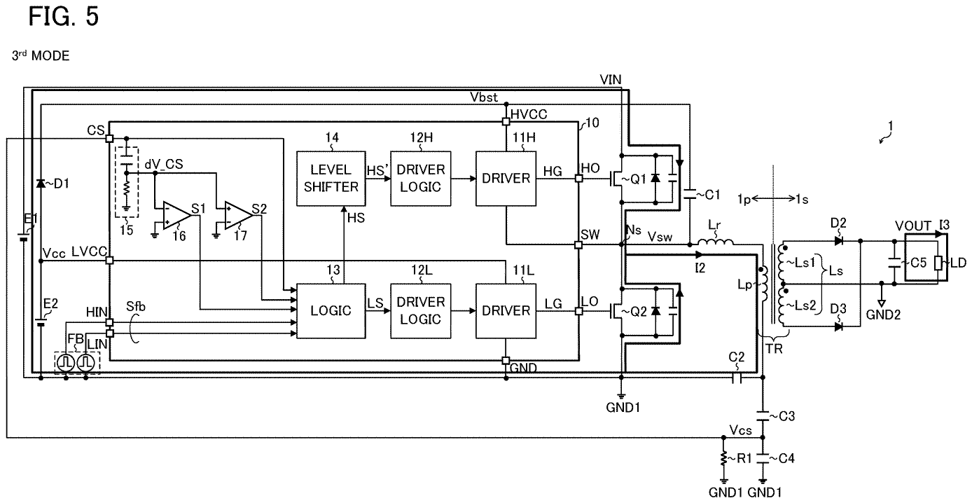

In the third mode subsequent to the second mode, the upper switch element Q1 is switched from an on state to an off state. As shown in FIG. 5, in the primary circuit system 1p, the excitation current I2 starts to charge the output capacitance of the upper switch element Q1, and simultaneously starts to discharge the output capacitance of the lower switch element Q2, and in the secondary circuit system Is, the load current I3 flows from the capacitor C5 to the load LD. When the charging of the output capacitance of the upper switch element Q1 and the discharging of the output capacitance of the lower switch element Q2 are completed, the operation of the switching power supply device 10 transitions from the third mode to the fourth mode.

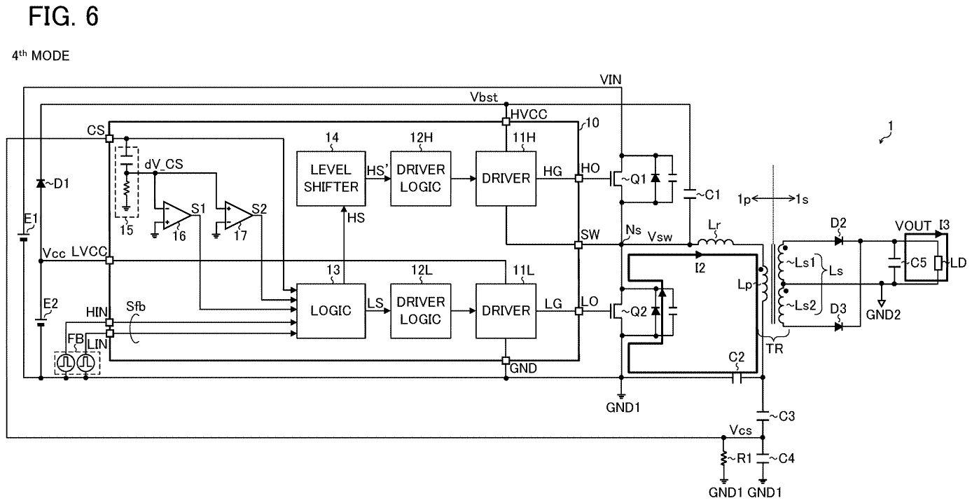

In the fourth mode, as shown in FIG. 6, in the primary circuit system 1p, the excitation current I2 flows via the body diode of the lower switch element Q2, and in the secondary circuit system Is, the load current I3 flows from the capacitor C5 to the load LD. The excitation current I2 flows through the body diode of the lower switch element Q2, and thus a voltage between the drain and source of the lower switch element Q2 becomes approximately 0 [V].

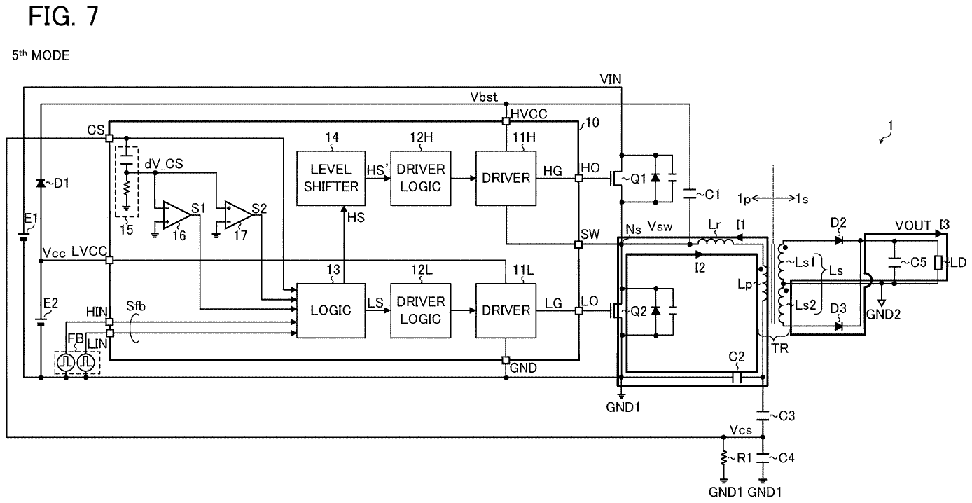

In the fifth mode subsequent to the fourth mode, the lower switch element Q2 is switched from an off state to an on state. Since the excitation current I2 flows through the body diode of the lower switch element Q2 before the lower switch element Q2 is switched from an off state to an on state, the turn-on operation of the lower switch element Q2 is a ZVS [Zero Voltage Switching] operation. The capacitor C2 is charged to function as a power supply. In this way, as shown in FIG. 7, in the primary circuit system 1p, the load current I1 is generated, and in the secondary circuit system Is, the load current I3 flows via the diode D3. Although the excitation current I2 flows in a direction opposite to the load current I1, since a negative voltage is applied to the primary winding Lp, the excitation current I2 is gradually reduced to then become a current flowing in the same direction as the load current I1.

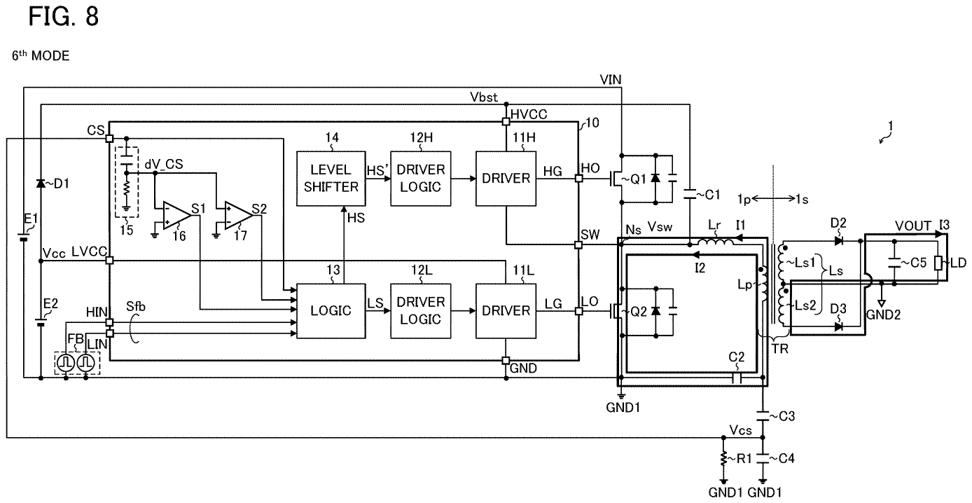

In the sixth mode subsequent to the fifth mode, the upper switch element Q1 is in an off state, and the lower switch element Q2 is in an on state. As shown in FIG. 8, in the primary circuit system 1p, the load current I1 and the excitation current I2 flow, and in the secondary circuit system 1s, the load current I3 flows via the diode D3. The load current I3 is the sinusoidal current caused by the resonance between the inductor Lr and the capacitor C2. When the load current I3 becomes 0 [A], the operation of the switching power supply device 10 transitions from the sixth mode to the seventh mode.

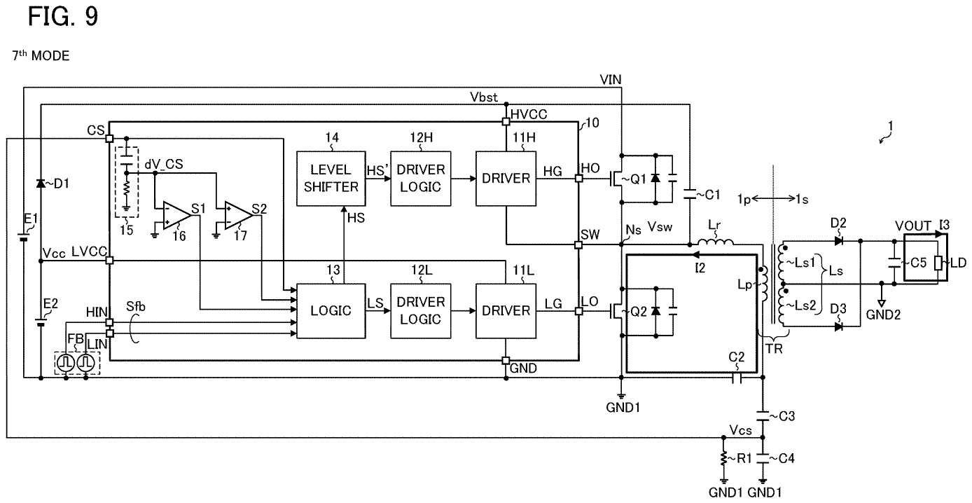

In the seventh mode, as in the sixth mode, the upper switch element Q1 is in an off state, and the lower switch element Q2 is in an on state. As shown in FIG. 9, in the primary circuit system 1p, the load current I1 is 0 [A] but the excitation current I2 continues to flow, and in the secondary circuit system 1s, the load current I3 flows from the capacitor C5 to the load LD. The capacitor C2 is charged by the excitation current I2. As the period of the seventh mode, that is, the charging period of the capacitor C2 is longer, the charge amount of the capacitor C2 is increased, and thus the direct-current output voltage VOUT is increased.

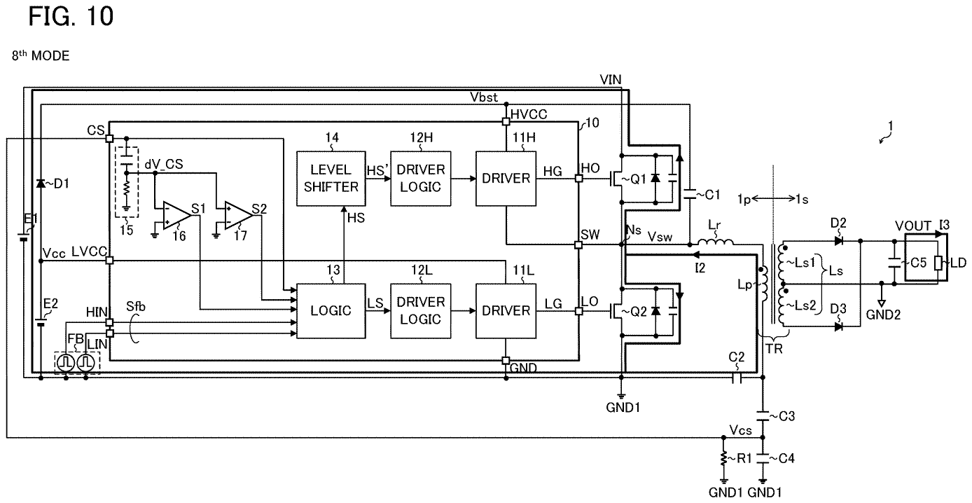

In the eighth mode subsequent to the seventh mode, the lower switch element Q2 is switched from an on state to an off state. As shown in FIG. 10, in the primary circuit system 1p, the excitation current I2 starts to charge the output capacitance of the lower switch element Q2, and simultaneously starts to discharge the output capacitance of the upper switch element Q1, and in the secondary circuit system Is, the load current I3 flows from the capacitor C5 to the load LD. When the charging of the output capacitance of the lower switch element Q2 and the discharging of the output capacitance of the upper switch element Q1 are completed, the operation of the switching power supply device 10 transitions from the eighth mode to the ninth mode.

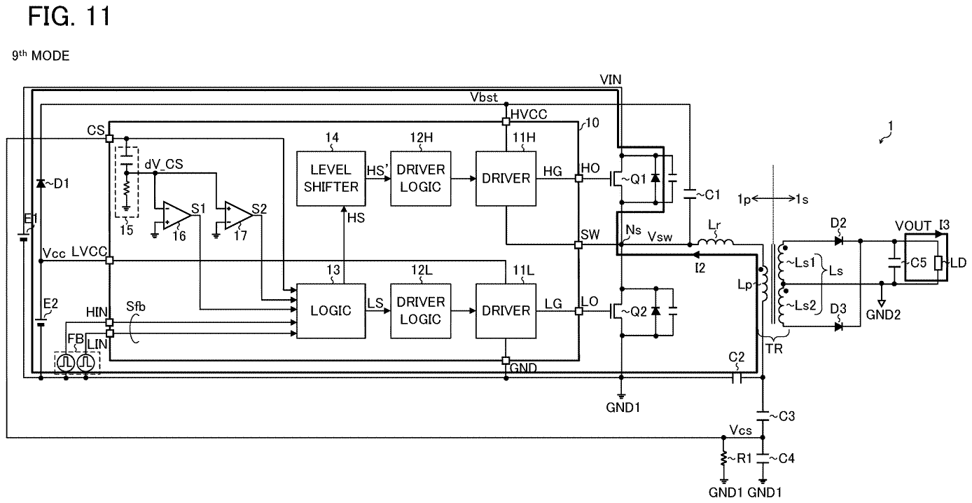

In the ninth mode, as shown in FIG. 11, in the primary circuit system 1p, the excitation current I2 flows via the body diode of the upper switch element Q1, and in the secondary circuit system 1s, the load current I3 flows from the capacitor C5 to the load LD. The excitation current I2 flows through the body diode of the upper switch element Q1, and thus a voltage between the drain and source of the upper switch element Q1 becomes approximately 0 [V].

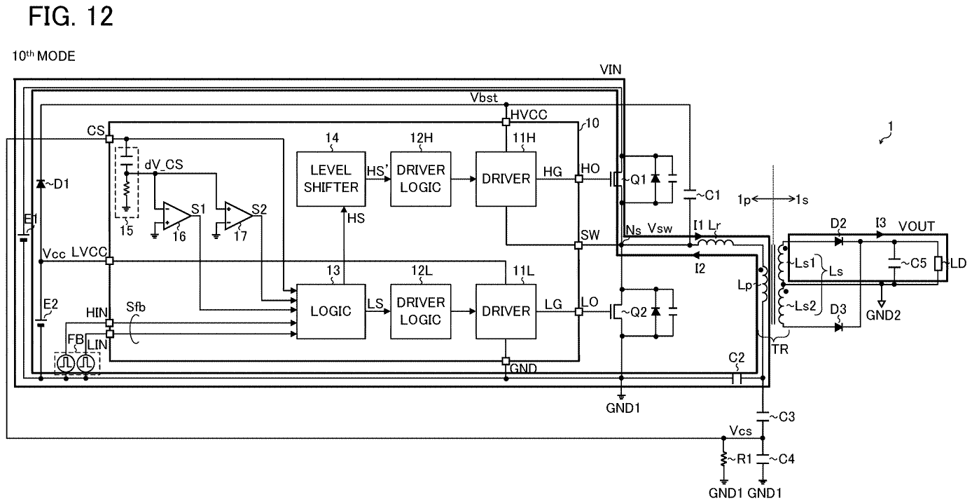

In the tenth mode subsequent to the ninth mode, the upper switch element Q1 is switched from an off state to an on state. Since the excitation current I2 flows through the body diode of the upper switch element Q1 before the upper switch element Q1 is switched from an off state to an on state, the turn-on operation of the upper switch element Q1 is the ZVS operation. The capacitor C2 is charged to function as a power supply. In this way, as shown in FIG. 12, in the primary circuit system 1p, the load current I1 is generated, and in the secondary circuit system Is, the load current I3 flows via the diode D2. Although the excitation current I2 flows in the direction opposite to the load current I1, since a negative voltage is applied to the primary winding Lp, the excitation current I2 is gradually reduced to then become a current flowing in the same direction as the load current I1.

### <Countermeasures Against Resonance Deviation>

The logic 13 uses the comparison result signals S1 and S2 to suppress the occurrence of a problem in which the switching frequency fsw enters a capacitive load region due to a fluctuation in the load to deviate from expected resonance conditions (resonance deviation).

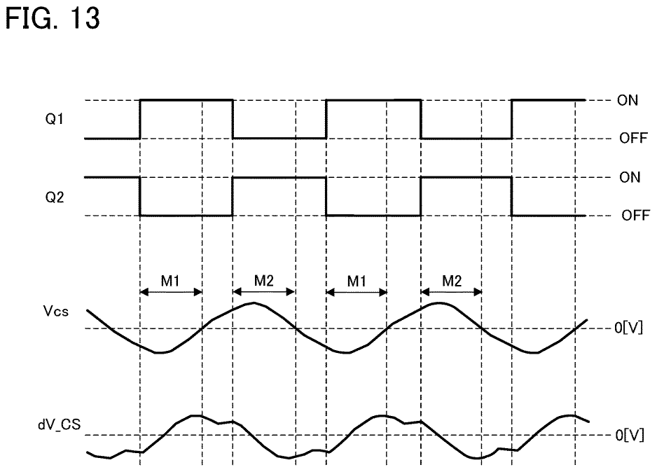

FIG. 13 is a diagram showing operation waveforms of the switching power supply device 10. FIG. 13 shows the state transition waveform of the upper switch element Q1, the state transition waveform of the lower switch element Q2, the waveform of the voltage Vcs which is the current sense signal and the waveform of the voltage dV_CS output from the high-pass filter 15. FIG. 13 is the diagram showing the operation waveforms when resonance deviation does not occur.

The logic 13 performs first control and second control.

The first control is the control in which when the upper switch element Q1 is in an on state, if after a first mask period M1, it is detected that a current flows from the capacitor C2 toward the primary winding Lp based on the voltage dV_CS, the logic 13 turns off the upper switch element Q1 regardless of duty cycle settings for the upper switch element Q1.

The logic 13 sets a timing at which the first mask period M1 is started to a time at which the upper switch element Q1 is turned on, that is, a timing at which the upper control signal HS is switched from low to high. The logic 13 sets a timing at which the first mask period M1 is completed based on the value of the voltage Ves which is the current sense signal. Specifically, the logic 13 sets the timing at which the first mask period M1 is completed to a timing at which the voltage Vcs serving as the current sense signal is switched from negative to positive. The logic 13 may set the timing at which the first mask period M1 is completed to a timing immediately before the voltage Vcs serving as the current sense signal is switched from negative to positive such as a timing at which voltage Vcs serving as the current sense signal becomes −0.1 [V].

Since the upper switch element Q1 is not turned off during the first mask period M1, it is possible to suppress the occurrence of a problem in which the logic 13 turns off the upper switch element Q1 due to erroneous detection.

The waveform of the voltage dV_CS reproduces the waveform of the current flowing through the primary winding Lp. When resonance deviation occurs, and the upper switch element Q1 is in an on state, a current flows from the capacitor C2 toward the primary winding Lp. Hence, when it is detected that a current flows from the capacitor C2 toward the primary winding Lp based on the voltage dV_CS, the logic 13 turns off the upper switch element Q1 regardless of the duty cycle settings for the upper switch element Q1, and thus resonance deviation is accurately suppressed.

In the present embodiment, the logic 13 uses the comparison result signal S1 output from the comparator 16 to detect that a current flows from the capacitor C2 toward the primary winding Lp when the upper switch element Q1 is in an on state. Specifically, when the high-level upper control signal HS is generated, the logic 13 checks the level of the comparison result signal S1, and detects that a current flows from the capacitor C2 toward the primary winding Lp when the comparison result signal S1 is high. On the other hand, when the low-level upper control signal HS is generated, the logic 13 checks the level of the comparison result signal S1, and does not detect that a current flows from the capacitor C2 toward the primary winding Lp when the comparison result signal S1 is low.

A configuration may be adopted in which not the ground voltage GND1 but a voltage (for example, 0.1 [V]) slightly higher than the ground voltage GND1 is applied to the non-inverting input terminal of the comparator 16. In this case, the logic 13 can detect a sign of the flowing of a current from the capacitor C2 toward the primary winding Lp, and thus it is possible to accurately prevent the occurrence of resonance deviation.

The second control is the control in which when the lower switch element Q2 is in an on state, if after a second mask period M2, it is detected that a current flows from the primary winding Lp toward the capacitor C2 based on the voltage dV_CS, the logic 13 turns off the lower switch element Q2 regardless of duty cycle settings for the lower switch element Q2.

The logic 13 sets a timing at which the second mask period M2 is started to a time at which the lower switch element Q2 is turned on, that is, a timing at which the lower control signal LS is switched from low to high. The logic 13 sets a timing at which the second mask period M2 is completed based on the value of the voltage Ves which is the current sense signal. Specifically, the logic 13 sets the timing at which the second mask period M2 is completed to a timing at which the voltage Vcs serving as the current sense signal is switched from positive to negative. The logic 13 may set the timing at which the second mask period M2 is completed to a timing immediately before the voltage Ves serving as the current sense signal is switched from positive to negative such as a timing at which voltage Vcs serving as the current sense signal becomes 0.1 [V].

Since the lower switch element Q2 is not turned off during the second mask period M2, it is possible to suppress the occurrence of a problem in which the logic 13 turns off the lower switch element Q2 due to erroneous detection.

As described above, the waveform of the voltage dV_CS reproduces the waveform of the current flowing through the primary winding Lp. When resonance deviation occurs, and the lower switch element Q2 is in an on state, a current flows from the primary winding Lp toward the capacitor C2. Hence, when it is detected that a current flows from the primary winding Lp toward the capacitor C2 based on the voltage dV_CS, the logic 13 turns off the lower switch element Q2 regardless of the duty cycle settings for the lower switch element Q2, and thus resonance deviation is accurately suppressed.

In the present embodiment, the logic 13 uses the comparison result signal S2 output from the comparator 17 to detect that a current flows from the primary winding Lp toward the capacitor C2 when the lower switch element Q2 is in an on state. Specifically, when the high-level lower control signal LS is generated, the logic 13 checks the level of the comparison result signal S2, and detects that a current flows from the primary winding Lp toward the capacitor C2 when the comparison result signal S2 is high. On the other hand, when the low-level lower control signal LS is generated, the logic 13 checks the level of the comparison result signal S2, and does not detect that a current flows from the primary winding Lp toward the capacitor C2 when the comparison result signal S2 is low.

A configuration may be adopted in which not the ground voltage GND1 but a voltage (for example, −0.1 [V]) slightly lower than the ground voltage GND1 is applied to the non-inverting input terminal of the comparator 17. In this case, the logic 13 can detect a sign of the flowing of a current from the primary winding Lp toward the capacitor C2, and thus it is possible to accurately prevent the occurrence of resonance deviation.

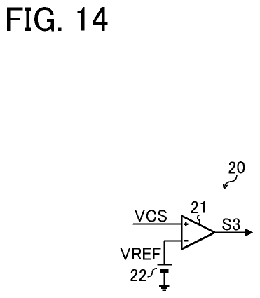

The semiconductor device 10 may include a determination circuit 20 which is configured to determine whether the voltage Vcs serving as the current sense signal is equal to or greater than a predetermined voltage. FIG. 14 is a diagram showing an example of the configuration of the determination circuit 20. The determination circuit 20 shown in FIG. 14 includes a comparator 21 and a reference voltage source 22. The voltage Vcs is applied to the non-inverting input terminal of the comparator 21. A reference voltage (predetermined voltage) VREF output from the reference voltage source 22 is applied to the inverting input terminal of the comparator 21. A comparison result signal S3 output from the comparator 21 is supplied to the logic 13 (not shown in FIG. 14).

When the comparison result signal S3 output from the comparator 21 is high, the logic 13 allows the upper switch element Q1 to be turned off in the first control, and allows the lower switch element Q2 to be turned off in the second control. On the other hand, when the comparison result signal S3 output from the comparator 21 is low, the logic 13 prevents the upper switch element Q1 from being turned off in the first control, and prevents the lower switch element Q2 from being turned off in the second control. In this way, it is possible to prevent erroneous detection of the direction of a current when the load is light and the amplitude of the current flowing through the primary winding Lp is small.

### OTHERS

It should be considered that the embodiment described above is illustrative in all respects, and not restrictive. It should be understood that the technical scope of the present disclosure is indicated not by the description of the embodiment described above but by the scope of claims, and meanings equivalent to the scope of claims and all changes in the scope are included therein.

For example, the logic 13 may perform only one of the first control and the second control. However, in the configuration in which the logic 13 performs both the first control and the second control, as compared with the configuration in which the logic 13 performs only one of the first control and the second control, it is possible to more reliably suppress resonance deviation when the load is changed rapidly.

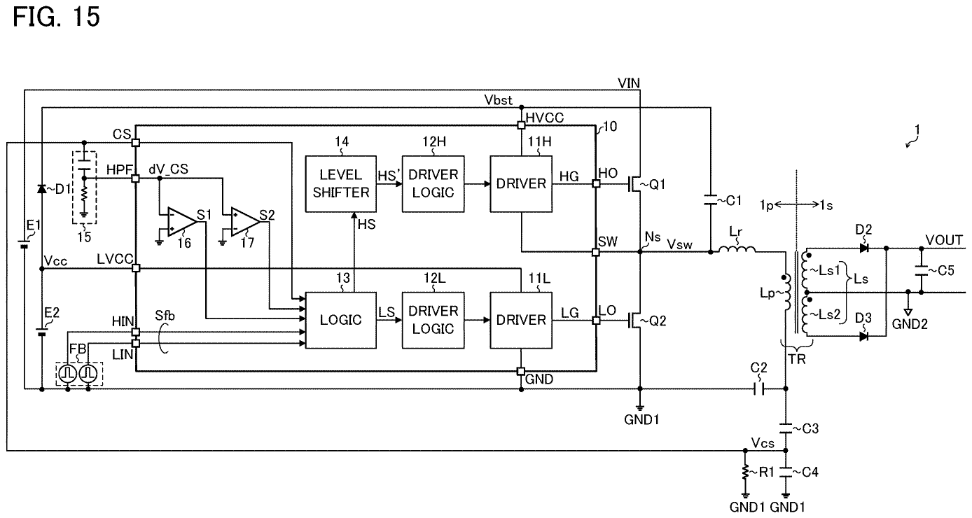

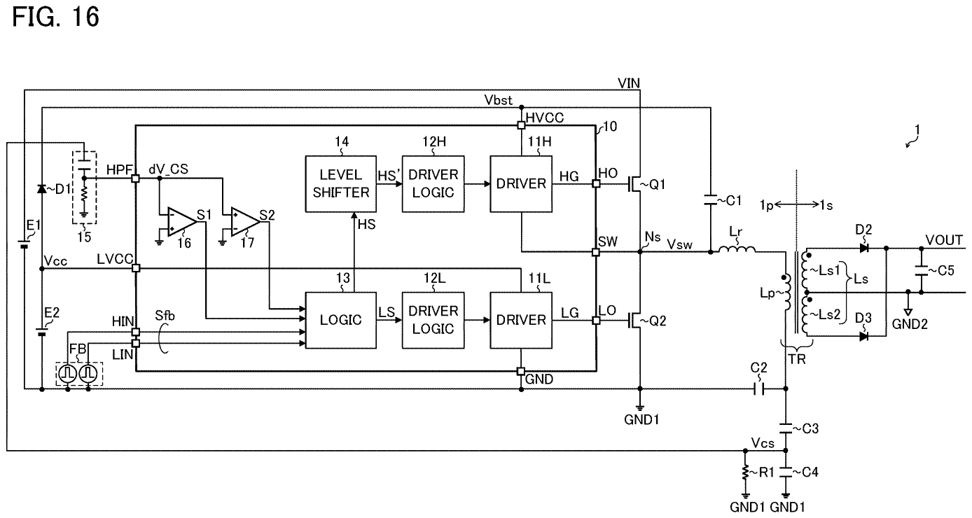

For example, as shown in FIG. 15, the high-pass filter 15 may be provided outside the semiconductor device 10, and an HPF pin to which the voltage dV_CS output from the high-pass filter 15 is applied may be provided in the semiconductor device 10. For example, when the current mode control method is not applied, as shown in FIG. 16, the CS pin does not need to be provided in the semiconductor device 10.

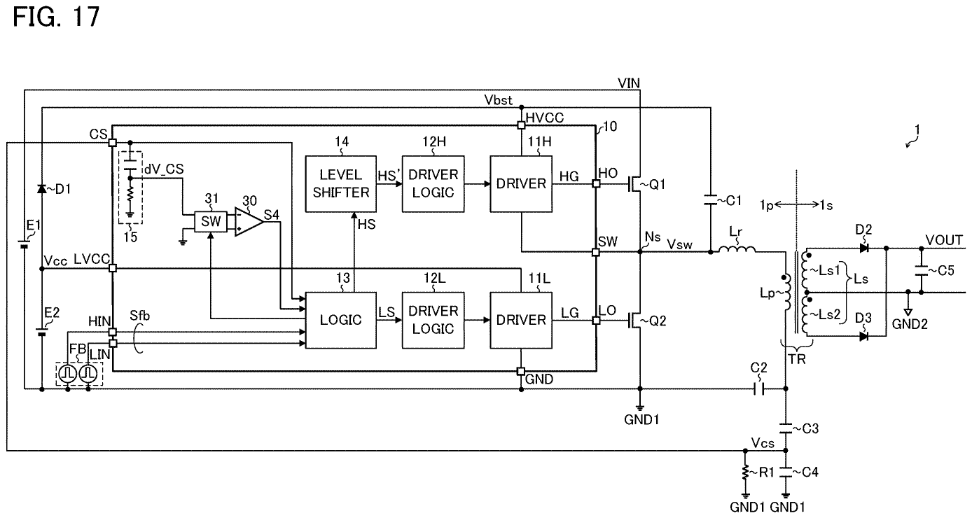

For example, as shown in FIG. 17, instead of the comparators 16 and 17, a comparator 30 and a switching circuit 31 may be provided in the semiconductor device 10. The switching circuit 31 is configured to switch between a first supply state where the voltage dV_CS is supplied to the inverting input terminal of the comparator 30, and the ground voltage GND1 is supplied to the non-inverting input terminal of the comparator 30 and a second supply state where the voltage dV_CS is supplied to the non-inverting input terminal of the comparator 30, and the ground voltage GND1 is supplied to the inverting input terminal of the comparator 30. The logic 13 controls the switching circuit 31 such that when the high-level upper control signal HS is generated, the switching circuit 31 is in the first supply state. The logic 13 also controls the switching circuit 31 such that when the high-level lower control signal LS is generated, the switching circuit 31 is in the second supply state.

### ADDITIONAL REMARKS

Additional remarks will be provided to the present disclosure in which the specific examples of the configuration have been shown in the embodiment described above.

A power supply control device (10) according to the present disclosure is configured to drive and control an LLC resonant converter, the LLC resonant converter includes: a first switch element (Q1) configured such that an input voltage (VIN) is applied to a first end; a second switch element (Q2) configured such that a first end is connected to a second end of the first switch element; a primary winding (Lp) and a resonant capacitor (C2) configured to be connected in series between a first connection node (Ns) and a second end of the second switch element, the second end of the first switch element and the first end of the second switch element being connected to the first connection node; a secondary winding (Ls) configured to be magnetically coupled to the primary winding; and a rectifier (D2, D3) configured to be connected to the secondary winding and the power supply control device includes the control circuit (13) configured to perform at least one of: first control in which when the first switch element is in an on state, if it is detected that a current flows from the resonant capacitor toward the primary winding based on a voltage (dV_CS) output from a high-pass filter (15) configured to receive a signal (Vcs) corresponding to a current flowing through the primary winding or a sign of the flowing of the current from the resonant capacitor is detected, the first switch element is turned off; and second control in which when the second switch element is in an on state, if it is detected that a current flows from the primary winding toward the resonant capacitor based on the voltage (dV_CS) output from the high-pass filter or a sign of the flowing of the current from the primary winding is detected, the second switch element is turned off (first configuration).

Since the waveform of the voltage output from the high-pass filter reproduces the waveform of the current flowing through the primary winding, the power supply control device of the first configuration performs at least one of the first control using the voltage output from the high-pass filter and the second control using the voltage output from the high-pass filter, and thereby can accurately suppress resonance deviation.

The power supply control device of the first configuration may include the high-pass filter (second configuration).

In the power supply control device of the first or second configuration, the control circuit may be configured to perform the first control, and configured such that when the first switch element is in an on state, if the current sense signal is equal to or greater than a predetermined voltage, and it is detected that the current flows from the resonant capacitor toward the primary winding based on the voltage output from the high-pass filter or the sign of the flowing of the current from the resonant capacitor is detected, the first switch element is turned off (third configuration).

In the power supply control device of any one of the first to third configurations, the control circuit may be configured to perform the first control, and configured such that when the first switch element is in an on state, if after a first mask period, it is detected that the current flows from the resonant capacitor toward the primary winding based on the voltage output from the high-pass filter or the sign of the flowing of the current from the resonant capacitor is detected, the first switch element is turned off (fourth configuration).

In the power supply control device of the fourth configuration, the first mask period may be started when the first switch element is turned on (fifth configuration).

In the power supply control device of the fourth or fifth configuration, the first mask period may be completed based on a value of the current sense signal (sixth configuration).

In the power supply control device of any one of the first to sixth configurations, the control circuit may be configured to perform the second control, and configured such that when the second switch element is in an on state, if the current sense signal is equal to or greater than a predetermined voltage, and it is detected that the current flows from the primary winding toward the resonant capacitor based on the voltage output from the high-pass filter or the sign of the flowing of the current from the primary winding is detected, the second switch element is turned off (seventh configuration).

In the power supply control device of any one of the first to seventh configurations, the control circuit may be configured to perform the second control, and configured such that when the second switch element is in an on state, if after a second mask period, it is detected that the current flows from the primary winding toward the resonant capacitor based on the voltage output from the high-pass filter or the sign of the flowing of the current from the primary winding is detected, the second switch element is turned off (eighth configuration).

In the power supply control device of the eighth configuration, the second mask period may be started when the second switch element is turned on (ninth configuration).

In the power supply control device of the eighth or ninth configuration, the second mask period may be completed based on a value of the current sense signal (tenth configuration).

The power supply control device of any one of the first to tenth configurations may further include: a first comparator (16) configured to compare the voltage output from the high-pass filter with a first threshold value (GND1); and a second comparator (17) configured to compare the voltage output from the high-pass filter with a second threshold value (GND1), and the control circuit may be configured to perform the first control and the second control, and configured such that when the first switch element is in an on state, using an output of the first comparator, it is detected that the current from the resonant capacitor toward the primary winding or the sign of the flowing of the current from the resonant capacitor is detected, and when the second switch element is in an on state, using an output of the second comparator, it is detected that the current flows from the primary winding toward the resonant capacitor or the sign of the flowing of the current from the primary winding is detected (eleventh configuration).

The power supply control device of any one of the first to tenth configurations may further include: a comparator (30) configured to compare the voltage output from the high-pass filter with a threshold value (GND1); and a switching circuit (31) configured to switch between: a first supply state where the voltage output from the high-pass filter is supplied to a first input end of the comparator, and the threshold value is supplied to a second input end of the comparator; and a second supply state where the voltage output from the high-pass filter is supplied to the second input end of the comparator, and the threshold value is supplied to the first input end of the comparator, and the control circuit may be configured to perform the first control and the second control, and configured such that when the first switch element is in an on state, using an output of the comparator when the switching circuit performs the first supply state, it is detected that the current flows from the resonant capacitor toward the primary winding or the sign of the flowing of the current from the resonant capacitor is detected, and when the second switch element is in an on state, using an output of the comparator when the switching circuit performs the second supply state, it is detected that the current flows from the primary winding toward the resonant capacitor or the sign of the flowing of the current from the primary winding is detected (twelfth configuration).

A switching power supply device (1) according to the present disclosure includes: the power supply control device of any one of the first to twelfth configurations; and the LLC resonant converter (thirteenth configuration).

What is claimed is:

1. A power supply control device configured to drive and control an LLC resonant converter, the power supply control device comprising:
a control circuit,
wherein the LLC resonant converter includes:
a first switch element configured such that an input voltage is applied to a first end;
a second switch element configured such that a first end is connected to a second end of the first switch element;
a primary winding and a resonant capacitor configured to be connected in series between a first connection node and a second end of the second switch element, the second end of the first switch element and the first end of the second switch element being connected to the first connection node;
a secondary winding configured to be magnetically coupled to the primary winding; and
a rectifier configured to be connected to the secondary winding, and
the control circuit is configured to perform at least one of:
first control in which when the first switch element is in an on state, if it is detected that a current flows from the resonant capacitor toward the primary winding based on a voltage output from a high-pass filter configured to receive a current sense signal corresponding to a current flowing through the primary winding or a sign of the flowing of the current from the resonant capacitor is detected, the first switch element is turned off; and
second control in which when the second switch element is in an on state, if it is detected that a current flows from the primary winding toward the resonant capacitor based on the voltage output from the high-pass filter or a sign of the flowing of the current from the primary winding is detected, the second switch element is turned off.

2. The power supply control device according to claim 1 comprising:
the high-pass filter.

3. The power supply control device according to claim 1,
wherein the control circuit is
configured to perform the first control, and
configured such that when the first switch element is in an on state, if the current sense signal is equal to or greater than a predetermined voltage, and it is detected that the current flows from the resonant capacitor toward the primary winding based on the voltage output from the high-pass filter or the sign of the flowing of the current from the resonant capacitor is detected, the first switch element is turned off.

4. The power supply control device according to claim 1,
wherein the control circuit is
configured to perform the first control, and
configured such that when the first switch element is in an on state, if after a first mask period, it is detected that the current flows from the resonant capacitor toward the primary winding based on the voltage output from the high-pass filter or the sign of the flowing of the current from the resonant capacitor is detected, the first switch element is turned off.

5. The power supply control device according to claim 4,
wherein the first mask period is started when the first switch element is turned on.

6. The power supply control device according to claim 4,
wherein the first mask period is completed based on a value of the current sense signal.

7. The power supply control device according to claim 1,
wherein the control circuit is
configured to perform the second control, and
configured such that when the second switch element is in an on state, if the current sense signal is equal to or greater than a predetermined voltage, and it is detected that the current flows from the primary winding toward the resonant capacitor based on the voltage output from the high-pass filter or the sign of the flowing of the current from the primary winding is detected, the second switch element is turned off.

8. The power supply control device according to claim 7,
wherein the control circuit is
configured to perform the second control, and
configured such that when the second switch element is in an on state, if after a second mask period, it is detected that the current flows from the primary winding toward the resonant capacitor based on the voltage output from the high-pass filter or the sign of the flowing of the current from the primary winding is detected, the second switch element is turned off.

9. The power supply control device according to claim 8,
wherein the second mask period is started when the second switch element is turned on.

10. The power supply control device according to claim 8,
wherein the second mask period is completed based on a value of the current sense signal.

11. The power supply control device according to claim 1 further comprising:
a first comparator configured to compare the voltage output from the high-pass filter with a first threshold value; and
a second comparator configured to compare the voltage output from the high-pass filter with a second threshold value,
wherein the control circuit is
configured to perform the first control and the second control, and
configured such that
when the first switch element is in an on state, using an output of the first comparator, it is detected that the current flows from the resonant capacitor toward the primary winding or the sign of the flowing of the current from the resonant capacitor is detected, and
when the second switch element is in an on state, using an output of the second comparator, it is detected that the current flows from the primary winding toward the resonant capacitor or the sign of the flowing of the current from the primary winding is detected.

12. The power supply control device according to claim 1 further comprising:
a comparator configured to compare the voltage output from the high-pass filter with a threshold value; and
a switching circuit configured to switch between:
a first supply state where the voltage output from the high-pass filter is supplied to a first input end of the comparator, and the threshold value is supplied to a second input end of the comparator; and
a second supply state where the voltage output from the high-pass filter is supplied to the second input end of the comparator, and the threshold value is supplied to the first input end of the comparator,
wherein the control circuit is
configured to perform the first control and the second control, and
configured such that
when the first switch element is in an on state, using an output of the comparator when the switching circuit performs the first supply state, it is detected that the current flows from the resonant capacitor toward the primary winding or the sign of the flowing of the current from the resonant capacitor is detected, and
when the second switch element is in an on state, using an output of the comparator when the switching circuit performs the second supply state, it is detected that the current flows from the primary winding toward the resonant capacitor or the sign of the flowing of the current from the primary winding is detected.

13. A switching power supply device comprising:
the power supply control device according to claim 1; and
the LLC resonant converter.
